(19) United States
(12) Patent Application Publication
(10) Pub. No.: US 2026/0130407 A1
(43) Pub. Date: May 14, 2026

(54) NUTRACEUTICAL DELIVERY SYSTEM

(71) Applicant: Exentis Knowledge GmbH, Stetten AG (CH)

(72) Inventors: David L. Deck, Baden (CH); Ralf P. Brammer, Baden (CH)

(21) Appl. No.: 19/388,465

(22) Filed: Nov. 13, 2025

Related U.S. Application Data
(63) Continuation of application No. 16/958,889, now abandoned.

(30) Foreign Application Priority Data
Dec. 29, 2017 (DE) 102017131428.8

(51) Int. Cl. A23P 20/20; A23L 33/105; A23L 33/15; A23L 33/16; A23L 33/175; A23P 20/25

(52) U.S. Cl. CPC A23P 20/20; A23L 33/105; A23L 33/15; A23L 33/16; A23L 33/175; A23P 2020/253; A23V 2002/00

(57) ABSTRACT

The present invention relates to a nutraceutical delivery system, particularly for a controlled administration of one or more active nutraceutical ingredients to a body, and further particularly for oral administration of one or more active nutraceutical ingredients to a body. The system may thus comprise a base component soluble in body fluids and also a separate first component. The base component and the separate first component may be soluble in body fluids. The first component may furthermore comprise an effective amount of a first active nutraceutical ingredient.

### CROSS REFERENCE TO RELATED APPLICATIONS

This application is a continuation of U.S. patent application Ser. No. 16/958,889 filed Jun. 29, 2020 which is the U.S. National Phase of International Patent Application No. PCT/EP2018/085751 filed on Dec. 19, 2018, which in turn claims the priority benefit of Germany Patent Application No. 10 2017 131 428.8 filed Dec. 29, 2017, the respective disclosures of which are each incorporated herein by reference in their entireties.

### BACKGROUND

### Field of the Disclosure

The present invention relates to a nutraceutical delivery system for a controlled, preferably systemic administration of one or more active nutraceutical ingredients to a body, preferably a human body. The nutraceutical delivery system is particularly configured for oral administration but not limited thereto.

### Brief Description of Related Technology

A nutraceutical is commonly used to provide additional health benefit. An active nutraceutical ingredient may be the part of any nutraceutical that produces its effects, in particular any desired health effect. Some nutraceuticals may have multiple active nutraceutical ingredients to achieve different benefits or act in different ways. Therefore, one or more active nutraceutical ingredients may be delivered by a nutraceutical. Even a high number of active nutraceutical ingredients may be delivered by a nutraceutical.

### SUMMARY

The delivery of nutraceuticals, or nutraceutical delivery, may refer to the transportation of a nutraceutical compound and/or ingredient into the body of a consumer as needed to safely achieve its desired effect, in particular its desired health effect. The delivery or administration of a nutraceutical into the body of a consumer, in particular a human, may be performed in various ways. Possible administration routes include, for example, the oral route. In case delivery or administration into a body of a consumer is performed via the oral route, the respective nutraceutical is provided through the mouth of the consumer, in order to enter via the oral mucosa or pass on into the gastrointestinal tract to reach the blood compartment via the gastric or intestinal mucosa.

Nutraceuticals can be provided in different dosage forms. The dosage forms may comprise, for example, pills, tablets, capsules, solutions, dispersions, emulsions.

A tablet may be a nutraceutical dosage form. A tablet may be a solid unit dosage form of a nutraceutical with an active nutraceutical ingredient, with or without suitable excipients. Tablets may commonly be prepared by molding or by compression. The manufacturing of tablets commonly requires that the appropriate or precise amount of active nutraceutical ingredient(s) is provided in each tablet. This may be essential in view of safety as well as effectiveness of the respective tablet. Therefore, all ingredients are well mixed. Thereby, a homogeneous mixture of the ingredients may be obtained. Subsequently, a particular amount of the mixture may be compressed in order to obtain a tablet. Accordingly, the active nutraceutical ingredient is typically homogeneously distributed within and/or throughout the tablet, or parts of it.

By applying a tablet, for example upon oral administration, the tablet may dissolve. The active nutraceutical ingredient may thereby be released. It may then pass the intestinal mucous membrane to reach the blood compartment and finally the tissue of action. With common nutraceutical delivery systems, for example tablets commonly manufactured, the concentration of the active nutraceutical ingredient within the blood compartment may typically be above the efficacy threshold of the given active nutraceutical ingredient for a certain period of time. During this period of time, the release of the active nutraceutical ingredient out of the nutraceutical delivery system into the gastrointestinal tract may typically be higher than actually required. Any excess amount of the active nutraceutical ingredient may not pass the membrane in sufficient amounts and be picked up by the body. Therefore, such excess amounts of the active nutraceutical ingredient may be excreted from the respective body. It is furthermore possible that excess amounts of the active nutraceutical ingredient reach the blood compartment and/or the tissue and cause possibly harmful effects.

In particular, release of active nutraceutical ingredients out of commonly designed and/or manufactured tablets is mainly driven by the size of the disintegrating tablet, in particular, the surface that is exposed to the surrounding fluid. As such it may be predefined by the form and size of the tablet and fixed, with, for example, a high release at the beginning and lowering over time. Blood and/or tissue concentrations of the active nutraceutical ingredient may thereby well exceed the respective efficacy threshold, in order to obtain a desired period of concentration above said threshold.

Such a release profile may particularly be disadvantageous for active nutraceutical ingredients with a narrow effective window. That is, in case of little differences between effective and harmful or excess doses, release profiles of common tablets may be particularly disadvantageous.

One problem underlying the present invention is to provide a more efficient nutraceutical delivery system, which allows a controlled administration of one or more active nutraceutical ingredients to a body and/or with an application-tailored and/or active-nutraceutical-ingredient-specific release profile.

A further object of the present invention is to provide a nutraceutical delivery system which enables a controlled administration of several active nutraceutical ingredients to a body. Particularly, an object may be to provide a nutraceutical delivery system which enables a release of ingredients such that the active nutraceutical ingredients are released relative to each other in a defined manner, preferably with desired active nutraceutical ingredient-specific release profiles.

A more general object of the invention may be considered as to optimize kinetics and dynamics of the intake of the active nutraceutical ingredient.

These and other objects, which may become apparent from the following description, are solved by a nutraceutical delivery system according to the disclosure. The usage of a nutraceutical delivery system according to the present invention is also disclosed herein.

The present invention relates to a nutraceutical delivery system. The nutraceutical delivery system may be a nutraceutical and may enable the transporting of an active nutraceutical ingredient into the body of a consumer, preferably a body of a human, as needed to safely achieve its desired effect and/or a number of desired effects.

The nutraceutical delivery system according to the present invention may include an active nutraceutical ingredient, or several active nutraceutical ingredients, or other ingredients. The nutraceutical delivery system may be a bioerodible nutraceutical delivery system. Thus, the nutraceutical delivery system may erode upon application thereof to a body of a consumer. Accordingly, the nutraceutical delivery system may, for example, dissolve upon application, such as in the mouth of the consumer.

The nutraceutical delivery system according to the present invention may be particularly suited for a controlled administration of one or more active nutraceutical ingredients to a body. The body may be the body of a consumer, which may be a human. It is also possible that the body is a body of an animal.

The nutraceutical delivery system according to the present invention may be used for oral administration of one or more active nutraceutical ingredients to a body. The system may dissolve in the mouth of the consumer. Therefore, with a nutraceutical delivery system according to the present invention, an active nutraceutical ingredient can be administered in a controlled manner. The manner of controlled administration may depend on the particular application case and/or the health effects to be achieved.

According to the present invention, the nutraceutical delivery system may comprise a base component being soluble in body fluids. Body fluids may, for instance, include blood, or body tissue fluids. Body fluids encountered may vary according to the administration route. In case of oral intake, the composition of the outer layer of the nutraceutical delivery system may determine whether or not dissolution of the nutraceutical delivery system will start in the mouth, thus leading to dissolution in saliva. Should the dissolution not start in the mouth, a later dissolution along the journey of the system through the gastrointestinal tract may be achieved, in particular, in the stomach, thus in an acidic milieu, the ileum, the jejunum and/or other places.

The dissolution characteristics of the nutraceutical delivery system may, dependent on the application case and/or the desired health effects, be chosen such that a suitable release of the active nutraceutical ingredient is obtained. A rather instant or a rather slow dissolution may be chosen.

According to the present invention, the nutraceutical delivery system my comprise a separate first component soluble in body fluids. The first component may therefore dissolve in a manner similar to the base component. Preferably, the base component and the first component may dissolve in the same body fluid.

According to the present invention, the first component is not mixed with the base component in a classical manner to form a homogeneous mixture. Instead, the first component is provided as a component separate to the base component. Therefore, the base component can be distinguished from the first component within the nutraceutical delivery system.

Furthermore, the first component comprises an effective amount of a first active nutraceutical ingredient. The first component may therefore comprise the active nutraceutical ingredient which shall be delivered or administered by means of the nutraceutical delivery system according to the present invention. The first active nutraceutical ingredient may, for example, be homogeneously distributed within the first component. The first component may furthermore comprise and/or be composed of several active nutraceutical ingredients. The active nutraceutical ingredients may be homogeneously distributed within the first component. The base component may likewise comprise an active nutraceutical ingredient or also a plurality of active nutraceutical ingredients.

According to the present invention, the first component is inhomogeneously arranged in the base component. In other words, the base component and the separate first component are not provided as a homogeneous mixture in the nutraceutical delivery system. Instead, the base component and the separate first component are provided separately from another, preferably in a particular and/or specifically chosen manner, wherein the first component is inhomogeneously arranged in the base component. The first component may, for example, be provided inhomogeneously or discontinuously along one, two or more preferably three spatial or orthogonal directions in the base component.

By arranging the components in this manner, the first component may be arranged in the system in such a controlled and/or desired manner, so that no homogeneous distribution of the first component is present throughout the system. Accordingly, no homogeneous distribution of the first active nutraceutical ingredient is present throughout the system. To the contrary, the inhomogeneity is specifically constituted and/or specifically chosen by the particular arrangement of the components. Although the base component and the first component are provided as separate components, the first component may be arranged inhomogeneously within a matrix and/or overall structure formed of the base component. For example, the amount of the first component arranged within the base component may increase gradually and/or stepwise along a particular direction and/or orientation throughout the system.

According to a preferred embodiment of the present invention, the base component may be provided or considered as a three-dimensional body, and the separate first component may be inhomogeneously arranged throughout the base component. Accordingly, the main body of the nutraceutical delivery system may be formed of the base component, and one or more particular parts and/or elements of the nutraceutical delivery system, which may, for example, be only of marginal size, may be formed of the first component.

According to a yet further preferred embodiment of the present invention, the first component may inhomogeneously be arranged in a three-dimensional manner. Thus, the first component may be inhomogeneously arranged in the base component, and at the same time the inhomogeneous arrangement may be provided three-dimensionally, that is, throughout a three-dimensional extent of the of the base component.

The base component and the first component may preferably be arranged on a virtual two-or three-dimensional grid. Each pixel of the grid may be occupied by the base component or by the first component. Accordingly, the first component may be arranged inhomogeneously in the base component, and may therefore be inhomogeneously arranged in the nutraceutical delivery system itself. The size and/or volume of each pixel may be in the range of 1 μm³ to 1 cm³, preferably in the range of 10 μm³ to 100 mm³, more preferably in the range of 100 μm³ to 10 mm³, and further preferred of about 1 mm³.

Preferably, the first component and the base component may be arranged such that two-or three-dimensional structures formed by the components in the nutraceutical delivery system may feature a resolution in the range of 10 dpi to 10000 dpi, preferably in the range of 100 dpi to 5000 dpi, further more preferably in the range of 200 dpi to 2000 dpi, and yet more preferably in the range of 500 dpi to 1000 dpi.

Due to the particular arrangement of the base component and the first component, it may be possible to obtain a particularly desired and/or specifically chosen release of the first active nutraceutical ingredient. Both of the base component and the first component may be soluble in body fluids. It may therefore be controlled at what time, within what time period, and/or at which rate or intensity the first active nutraceutical ingredient is released from the nutraceutical delivery system. The release characteristic may be influenced by controlling the inhomogeneous arrangement of the first component relative to the base component. Thereby, a nutraceutical delivery system with an improved or optimal active nutraceutical ingredient release, particularly for a controlled administration of a given active nutraceutical ingredient to a body.

The release of the active nutraceutical ingredient may be determined only by the dissolution characteristics of the components and/or the form of the nutraceutical delivery system. No further release agents are required, such as, for example, osmotic agents for releasing the active nutraceutical ingredient.

The common principle of a homogeneous distribution of an active nutraceutical ingredient throughout a nutraceutical delivery system may be suspended in accordance with the present invention. It is therefore possible to provide a particular arrangement of the active nutraceutical ingredient within the system, in order to obtain a nutraceutical delivery system with a customized and/or specifically adjusted release profile of the active nutraceutical ingredient.

According to the present invention, the component comprising the active nutraceutical ingredient may, for example, be arranged and/or adjusted such that a steady release of the active nutraceutical ingredient is obtained. The release may preferably results in a blood and/or tissue concentration slightly above the efficacy threshold of the active nutraceutical ingredient. As compared to the common nutraceutical delivery system with a homogeneous distribution of the active nutraceutical ingredient, a significantly less amount of active nutraceutical ingredient may advantageously be required with the nutraceutical delivery system according to the present invention. At the same time, physiological results may be maintained and/or desired health effects may be obtained with lower side effects.

According to the present invention, the inhomogeneous distribution of an active nutraceutical ingredient in the nutraceutical delivery system may be utilized in a standardized manner, whereby a particular arrangement and/or adjustment of the components may be chosen or set. This concept enables the providing of nutraceutical delivery systems with the advantageous and/or customized release profiles. The standardization, definition and/or specification of the arrangement of the components, and therefore also the standardization, definition and/or specification of the inhomogeneity of the active nutraceutical ingredient allows for producing such nutraceutical delivery systems uniformly in high quantity, and at the same time also in a mass production.

The release profile and/or release characteristic of the active nutraceutical ingredient may be, for example, be configured and/or adjusted such that release of the active nutraceutical ingredient at a constant rate over a prolonged period of time is be provided. In other scenarios, a particularly slow release of an active nutraceutical ingredient to a body, with a release rate slightly above the efficacy threshold of the active nutraceutical ingredient, may be provided. The rate of release may in this case be approximately independent of time. According to a further preferred scenario, the release profile and/or characteristic may be configured for release of the active nutraceutical ingredient at particular intervals, for example, intermittently over time. According to yet a further preferred scenario, the release of several active nutraceutical ingredients one after the other, or simultaneously at individual release rates, may be provided, particularly with active nutraceutical ingredient-specific release profiles and/or characteristics.

Any or all of the components of the nutraceutical delivery system may comprise water, polyvinylpyrrolidone, citric acid, hypromellose, stearate, silic acid, glycerol, Hydroxypropyl cellulose, hydroxypropyl methylcellulose, starch, cellulosecrosscaramelose, glycol, crystalline gelatin, collagen, hydroxyapatite, hydrocarbonate, lactide, lactic acid, silica, polaxamers, xylitol, erythritol, ethanol, isopropanol, triacetin, aspartame, sodium bicarbonate, and/or acetone.

According to a preferred embodiment of the nutraceutical delivery device, the concentration of the first active nutraceutical ingredient may vary throughout the nutraceutical delivery system. Preferably, the concentration of the first active nutraceutical ingredient may vary throughout the body and/or structure defined by the base component. As an example, the first component may be provided at central parts of the nutraceutical delivery system only. Accordingly, particular regions of the nutraceutical delivery system may be identified having a comparably high concentration of the first active nutraceutical ingredient, and other particular regions may be identified having a comparably low or even no concentration of the first active nutraceutical ingredient.

Taking into consideration the particular form or shape of the nutraceutical delivery system, as well as the dissolution characteristics of the base component and/or first component, it may be possible to precisely control when and how the active nutraceutical ingredient is eventually released.

According to a further preferred embodiment, the concentration of the first active nutraceutical ingredient may be higher or highest at a center, at an edge or at an intermediate region of the system. For example, for the case of the nutraceutical delivery system being provided in form of a tablet, the first component may be arranged in order for a peak concentration of the first active nutraceutical ingredient being provided at the center or a central part of the tablet. Therefore, upon administration of the tablet and/or dissolution of the base component and/or the first component, the release of the first active nutraceutical ingredient may increase over time, and/or may remain approximately constant over time or a certain period of time. This may also depend on the shape of the nutraceutical delivery system. Thereby, a desired, specific release of the active nutraceutical ingredient may be obtained.

According to a yet further preferred embodiment, a possible gradient of concentration of the first active nutraceutical ingredient may increase towards or may increase away from a center of the nutraceutical delivery system. As an example, the amount of the first component may increase towards the center of the nutraceutical delivery system. If the nutraceutical delivery system is provided in form of a spherical tablet with the concentration of the first component and thus of the first active nutraceutical ingredient increasing towards the center of the tablet, the arrangement of the first component and thus of the first active nutraceutical ingredient may be in manner such that the release rate is approximately constant upon application of the nutraceutical delivery system. The adjustment of the concentration profile of the active nutraceutical ingredient throughout and/or within a portion of the the nutraceutical delivery system, the release profile of the active nutraceutical ingredient may well be controlled.

According to a yet further preferred embodiment, a concentration profile of the first active nutraceutical ingredient throughout the system may comprise a smooth transition to an area of increased or relatively high concentration. The concentration profile may therefore comprise a smooth transition between an area of low or possibly no concentration, and an area of high or higher concentration. As an example, the amount of the first component may increase gradually towards the center of the nutraceutical delivery system. It is possible to define a smooth transition by the absence of abrupt or discontinuous steps in the concentration profile. The concentration profile may represent the profile of the concentration of the first active nutraceutical ingredient diagonally across the nutraceutical delivery system, for instance, from one edge of the system to its center, or also possibly extending through the entire nutraceutical delivery system. With such smooth transitions, it may be possible to obtain a smooth beginning or starting point of release of the active nutraceutical ingredient upon dissolution of the respective components.

According to a yet further preferred embodiment, a concentration profile of the first active nutraceutical ingredient throughout the system may comprise more than one area of increased and/or comparatively high concentration. Thus, it may be possible to administer several dosages of the active nutraceutical ingredient over time with such nutraceutical delivery system.

It may be particularly preferred that the deposition of the first active nutraceutical ingredient within the nutraceutical delivery system along a dissolution direction, that is from the periphery to the center, is discontinuous and/or repetitive in an onion skin type manner. In each such shell of the system, the first component may be provided inhomogeneously, in order for a release of the first active nutraceutical ingredient may not start in an abrupt manner. To the contrary, a release of the first active nutraceutical ingredient can be set, in order for the release to start and/or end gradually and/or successively. The release of the respective active nutraceutical ingredient may therefore occur in distinct waves. Intervals with high release of the first active nutraceutical ingredient may be followed by intervals with low or no release or vice versa. It may furthermore be of advantage if the active nutraceutical ingredient is administered in several phases over time. These phases, and in particular their onset, may be controlled by controlling the arrangement of the areas of increased and/or reduced concentration within and/or throughout the system.

According to a further preferred embodiment, a possible variation of the concentration of the first active nutraceutical ingredient throughout and/or within a portion of the system may be at least 5%, preferably at least 10%, more preferably at least 15%, more preferably at least 20%, more preferably at least 25%, more preferably at least 30%, more preferably at least 35%, more preferably at least 40%, more preferably at least 45%, more preferably at least 50%, more preferably at least 55%, more preferably at least 60%, more preferably at least 65%, more preferably at least 70%, more preferably at least 75%, more preferably at least 80%, more preferably at least 85%, more preferably at least 90%, more preferably at least 95%, more preferably approximately 100%.

According to a yet further preferred embodiment of the invention, a possible variation of the concentration of the first active nutraceutical ingredient throughout the system my be at most approximately 100%, preferably at most 95%, more preferably at most 90%, more preferably at most 85%, more preferably at most 80%, more preferably at most 75%, more preferably at most 70%, more preferably at most 65%, more preferably at most 60%, more preferably at most 55%, more preferably at most 50%, more preferably at most 45%, more preferably at most 40%, more preferably at most 35%, more preferably at most 30%, more preferably at most 25%, more preferably at most 20%, more preferably at most 15%, more preferably at most 10%, more preferably at most 5%. Accordingly, the variation of the concentration can be set and/or adjusted in a controlled manner, particularly by providing a respective local arrangement of the first component within and/or relative to the base component, in order to eventually obtain a desired controlled administration of the first active nutraceutical ingredient.

According to a further embodiment, the variation of the concentration of the first active nutraceutical ingredient may be defined as the difference of the maximum concentration and the minimum concentration of the active nutraceutical ingredient in the system and/or within a portion of the system. In this context, the concentration may be the mass-specific concentration. The respective sampling volume for measuring the concentration may be any suitable volume, and may possibly be of 1 μm³. As an example, if the highest concentration in a sampling volume in the system or in a portion of the system is of about 80%, and if the lowest concentration in a sampling volume in the system or in a portion of the system is of about 10%, the variation may thus be 70%. Accordingly, throughout the nutraceutical delivery system, the concentration of the first active nutraceutical ingredient may be at least 10%. At a central part of the nutraceutical delivery system, the concentration of the first active nutraceutical ingredient may increase to 80%.

According to a yet further preferred embodiment, the concentration profile of the first active nutraceutical ingredient may be such that with application of the system, the first active nutraceutical ingredient is released from the system at a predetermined release profile. Such release profile may preferably comprise a section with a release at a constant rate or an approximately constant rate. The first component may therefore be arranged in such a manner within the base component that with application of the nutraceutical delivery system, and with dissolution of the base component and/or first component, a particular and/or previously adjusted release profile of the active nutraceutical ingredient may be obtained. This release profile may have a constant release section according to a preferred embodiment.

According to a further preferred embodiment of the present invention, the first component may be arranged in the base component such that upon dissolution of the system or the components, the total amount of the first active nutraceutical ingredient at an outer surface of the system remains approximately constant for a predetermined time. The predetermined time may preferably be in the range of 1 second up to 24 hours. As an example, the amount of the first component may increase towards central parts or central portions of the nutraceutical delivery system. Depending on the respective application and the form of the nutraceutical delivery system, rather longer or rather shorter release periods may be adjusted.

In case the nutraceutical delivery system is provided in form of a tablet, for instance, the active nutraceutical ingredient may preferably be released during a period of up to 12 hours. Further preferred, the predetermined time of approximately constant release may be in the range of 5 seconds to 24 hours, preferably 10 seconds to 12 hours, more preferably 1 minute to 6 hours, more preferably 10 minutes to 1 hour.

In the exemplary case of a spherical tablet, a gradient of the concentration of the first active nutraceutical ingredient may point inwards, in order for the amount of active nutraceutical ingredient at the surface of the system to remain constant when the system is dissolving, that is, when the volume and surface of the system shrinks. Accordingly, the first component may be arranged in a manner such that eventually the concentration of the first active nutraceutical ingredient depends on the distance to the surface of the system. By inhomogeneously arranging the first component in the base component, a constant release of the first active nutraceutical ingredient may therefore be achieved, for example.

According to a further preferred embodiment of the present invention, the concentration profile of the first active nutraceutical ingredient may be such that with application of the nutraceutical delivery system, the first active nutraceutical ingredient is released at two or more dosages. The release of the first active nutraceutical ingredient at one of the dosages may start 1 second to 24 hours, preferably 5 seconds to 12 hours, more preferably 10 seconds to 6 hours, more preferably 20 seconds to 2 hours, more preferably 1 minute to 1 hour, and most preferred 10 minutes to 30 minutes before release of the first active nutraceutical ingredient at another one of the dosages. The first component may, for example, be provided at several, separated locations towards a center of the nutraceutical delivery system. Thus, if the nutraceutical delivery system is provided in form of a tablet, for example, and with oral administration of such tablet, the first active nutraceutical ingredient may be released at a first dosage shortly after administration, before the first active nutraceutical ingredient is released at a second dosage at a later time. The dosages may be provided in uniform manner or may vary among each other. The duration of any release of a nutraceutical active ingredient mentioned herein may be measured by means of dissolution tests. The dissolution test may be, for example, according to USP-Guideline “General Chapter <711> Dissolution”.

According to a yet further preferred embodiment, the base component may envelop the system and the first component may not be arranged at an outer face of the system. The outer face of the system may be free of the first component. Accordingly, the first component comprising the first active nutraceutical ingredient may be provided in a manner such that it cannot be accessed and/or seen from the outside, at least prior to the application of the system. Accordingly, the first active nutraceutical ingredient may be effectively sealed from the environment, which can reduce the risk of a possible contamination. In case the nutraceutical delivery system is provided in form of a tablet, the dissolution of the first component may possibly be delayed upon oral administration. This is due to the fact that the base component has to dissolve first or at least partially dissolve first. A delayed administration of the first active nutraceutical ingredient may therefore be obtained.

According to a preferred embodiment, the nutraceutical delivery system may be configured in a manner such that release of the first active nutraceutical ingredient starts 1 second to 24 hours, preferably 10 seconds to 12 hours, more preferably 30 seconds to 6 hours, more preferably 1 minute to 4 hours, more preferably 10 minutes to 2 hours, more preferably 30 minutes to 1 hour after application of the nutraceutical delivery system.

According to a yet further preferred embodiment of the present invention, the nutraceutical delivery system may further comprise a separate second component. The second component may be soluble in body fluids. The second component may comprise an effective amount of a second active nutraceutical ingredient. Accordingly, the nutraceutical delivery system may allow the controlled administration of several active nutraceutical ingredients in particular applications. In case of several active nutraceutical ingredients an interaction of said ingredients after dissolution of the respective component. A synergetic effect in the body may thereby be achieved. It is possible that the first and second active nutraceutical ingredient differ in their form as well as in their concentration.

The provisions given herein in view of the first component and the first active nutraceutical ingredient may similarly apply in an analogous manner to the second component and/or the second active nutraceutical ingredient. The nutraceutical delivery system may also comprise further components comprising further active nutraceutical ingredients. Accordingly, there may be provided a third component comprising a third active nutraceutical ingredient, a fourth component comprising a fourth active nutraceutical ingredient, a fifth component comprising a fifth active nutraceutical ingredient, and so on.

According to a yet further embodiment of the present invention, the second component may be inhomogeneously arranged in the base component. Therefore, the release of the first active nutraceutical ingredient and also the second active nutraceutical ingredient can be controlled also relatively to each other. This may be achieved by controlling the inhomogeneous arrangement of the respective first and second components within the base component. Any explanation above with regard to the inhomogeneous arrangement may also apply in this regard.

According to a yet further embodiment of the present invention, a concentration profile of the first active nutraceutical ingredient throughout and/or within a portion of the system may be different than a concentration profile of the second active nutraceutical ingredient throughout and/or within a portion of the system. As an example, the amount of the first component may increase towards a center of the nutraceutical delivery system. To the contrary, the amount of the second component may decrease towards the center of the nutraceutical delivery system. Furthermore, the nutraceutical delivery system may be configured and/or designed in a manner such that the first active nutraceutical ingredient and the second active nutraceutical ingredient are released to the respective body of the consumer at different dosages.

According to a yet further embodiment of the present invention, the first component and the second component may be arranged in a discontinuous manner within the nutraceutical delivery system. The first active ingredient may therefore be released for a distinct and/or limited period of time upon the start of the dissolution of the system. Typically the dissolution may occur and/or start from the periphery. In a manner similar to an onion skin type arrangement, any layer with the first component may, for example, be adjacent to another layer containing either no active nutraceutical ingredient or the second active nutraceutical ingredient. Parameters such as the thickness of the layers, their composition, and/or the distribution of the active nutraceutical ingredients within the layers, may be varied. The release of the active nutraceutical ingredients may thereby be controlled.

According to a yet preferred embodiment, at least one layer of the nutraceutical delivery system may be resistant to dissolution in certain body fluids or certain body environments and/or may dissolute in certain body fluids or environments at in a delayed manner. It is also possible that at least one layer of the nutraceutical delivery system may be resistant to dissolution in certain body fluids or environments and may dissolute in other body fluids or environments. Thus, at least one layer may have dissolution resistant or dissolution delaying properties. A plurality of such layers may be provided. Such layers may, for example, be arranged on two sides of a possible third layer in a sandwich type configuration. In this case, the third layer may, for example, only be subject to dissolution from the narrow side or from its edges. The remaining sides or surfaces are protected from being contacted by body fluids or tissue due to the arrangement of the further layers, which do not dissolute in the respective body fluid or environment, or dissolute only in a delayed manner. The possibilities of control the administration of an ingredient or different ingredients may thereby by further improved.

According to a yet further preferred embodiment of the present invention, the first component and the second component may be arranged in the system in a manner such that with application of the system, release of the first active nutraceutical ingredient starts before release of the second active nutraceutical ingredient. The second component may, for example, be arranged closer to the center of the nutraceutical delivery system. In contrast, the first component may be arranged further or closer to the edge of the nutraceutical delivery system.

A possible release of the first active nutraceutical ingredient may preferably start 1 second to 24 hours, more preferably 5 seconds to 12 hours, more preferably 10 seconds to 6 hours, more preferably 20 seconds to 2 hours, more preferably 1 minute to 1 hour, and most preferably 10 minutes to 30 minutes before release of the second active nutraceutical ingredient.

Due to the particular inhomogeneous or discontinuous arrangement of the first and second components within the base component, preferably in view of the dissolution direction, it may be possible to control at what time the respective first and second active nutraceutical ingredients are released relative to one another and/or in which part of the body the respective first and second active nutraceutical ingredients are released. The release of the two active nutraceutical ingredients may, for example, be separated by a defined time interval depending on a possible spatial arrangement of the first and second active nutraceutical ingredients within the layers. It is also possible that the release of the first active nutraceutical ingredient continues when the release of the second active nutraceutical ingredient starts. Particular synergetic effects of the active nutraceutical ingredients may thereby be obtained. The active nutraceutical ingredients may generally be released to the body within seconds, minutes and/or hours. The time of release of the active nutraceutical ingredients may depend on the individual form of application.

According to a yet further preferred embodiment, the first component and the second component may be arranged within the system in a manner such that with application of the system, a release profile of the first active nutraceutical ingredient differs from a release profile of a second active nutraceutical ingredient.

The first active nutraceutical ingredient may, for example, be released at a rather constant rate. In contrast, the second active nutraceutical ingredient may be released intermittently or periodically. Therewith, an elaborate nutraceutical delivery system may be designed.

According to a yet further preferred embodiment, the total amount of the first active nutraceutical ingredient in the system may be between 1 μg and 100 g, preferably between 10 μg and 10 g, more preferably between 100 μg and 1 g, more preferably between 500 μg and 500 mg, more preferably between 1 mg and 100 mg, more preferably between 10 mg and 50 mg. Any description with regard to the first active nutraceutical ingredient may, in the present context, also apply to a possible second or any further active nutraceutical ingredients provided in a second or further components of the nutraceutical delivery system.

According to a yet further preferred embodiment of the present invention, one or more of the components may comprise a ceramic, metal, polymer and/or minerals. A polymer may preferably be a polymer acrylate, or the like.

According to a yet further preferred embodiment of the present invention, one or more of the components may comprise a disintegration agent. Such a disintegration agent may possibly facilitate the dissolution of any one of the respective components. Such disintegration agent may, for example, comprise cellulose, preferably in the form of microcrystalline cellulose, croscarmelose sodium, crospovidone, starches, preferably in the form of modified starches, cross-linked polyvinylpyrrolidone, sodium starch glycolate, and/or sodium carboxymethylcellulose.

According to a yet further preferred embodiment of the present invention, one or more of the components may comprise one or more of the following constituents: colorant, sweetener, flavor, antimicrobial preservative, chemical stabilizers, viscosity modifiers, and/or cellulosic materials. Any antimicrobial preservative may be a sorbic acid, benzoic acid, parabens, scrose, benzalkonium chloride, for example. Any chemical stabilizer may be used to increase the chemical stability of the nutraceutical active ingredient. Any chemical stabilizer may be an antioxidant such as ascorbic acid or sodium metabisulfite, or a chelator such as ethylenediaminetetraacetic acid, for example. Any viscosity modifier may be used to reduce the sedimentation of particles. Viscosity modifiers may be polymeric materials or inorganic materials such as clay, for example. Any cellulosic material may be used as viscosity enhancers in suspensions. Cellulosic materials may be cellulose, cellulose ethers, or alginic acid, for example.

According to a yet further preferred embodiment of the present invention, one or more of the components may comprise one or more of the following excipients: filler, solution binder, dry binder, and/or glidant. A filler may, for example comprise or be composed of lactose, sucrose, glucose, mannitol, sorbitol, calcium carbonate, and/or cellulose. A solution binder may, for example, comprise or be composed of gelatin, polyvinylpyrrolidone, cellulose derivative, and/or polyethylene glycol. A dry binder may, for example, comprise or be composed of cellulose, polyethylene glycol, and/or methylcellulose. A glidant may for example, comprise or be composed of silica, magnesium stearate, and/or talc.

According to a yet further preferred embodiment of the present invention, the first component may be provided in a geometrical shape, particularly in a predefined geometrical shape. The shape may, for example, be a tube, such as a hollow tube, a spot, such as a local, small cluster and/or agglomeration, an oval, particularly comprising the shape of an open circle or ellipse, a plate, and/or a polygon, such as in the shape of a square. Accordingly, the first component may be provided in such a shape that a desired or intended release of the first active nutraceutical ingredient may be obtained, also in view to further active nutraceutical ingredients, which may be provided in further components of the system. Within such particular and/or specifically adjusted geometrical shape, the concentration of the active nutraceutical ingredient may vary.

According to a yet further preferred embodiment of the present invention, the nutraceutical delivery system may further comprise a marking component. Such a marking component may be optically different from the base component and/or from the first or second component. The marking component may be arranged in a manner such that it forms a two-dimensional pattern on the surface of the system. A two-dimensional pattern may preferably be visible from the outside. Such a marking component may, for example, have a different color than the base component. A marking component with a particular and desired two-dimensional pattern, may allow providing the nutraceutical delivery system with a predefined symbol, logo, brand name, or the like. Thereby, a security feature may be provided. Such a security feature may allow for a user to authenticate the origin of the nutraceutical delivery system.

According to yet another preferred embodiment of the present invention, the first component may be optically different from the base component. The first component may furthermore be arranged in a manner such that it forms a two-dimensional pattern on the surface of the system. Such a pattern may, for example, be visible for a consumer from the outside. The first component may possibly have a different and/or distinguishable color than the base component. For example, a logo or the like may be formed by the first component. Therewith, also a sort of security feature may be provided, if required for the respective application.

According to yet another preferred embodiment of the present invention, the two-dimensional pattern may be a discontinuous pattern. the two-dimensional pattern may, for example, be due to an inhomogeneous arrangement of the respective component within the base component. The strength of the authentication level of the security feature may thereby be improved. This may furthermore increase the confidence of the respective user in the product.

According to yet another preferred embodiment of the present invention, the nutraceutical delivery system may be provided in the form of a tablet, a capsule, a disc, a film, pellets or granules. The nutraceutical delivery system according to the present invention may accordingly be provided in various forms. The nutraceutical delivery system may therefore allow for a desired administration and/or desired release of any active nutraceutical ingredient or a plurality of ingredients according to the particular application.

The nutraceutical delivery system may, according to a further preferred embodiment, be provided with a structured surface. The surface of the nutraceutical delivery system may, as an example, comprise protrusions and recesses or other shaped portions formed thereon. The surface of the resulting nutraceutical delivery system may, for example, be enlarged. A possibly high release of the respective active nutraceutical ingredient may thereby be provided for.

The nutraceutical delivery system may, according to a further preferred embodiment, be free of any fluorescent component. The nutraceutical delivery system may also comprise a fluorescent component, for example, in order to mark different portions of the system.

The nutraceutical delivery system according to the present invention is not limited to any particular active nutraceutical ingredient. Quite contrary, any suitable active nutraceutical ingredient, which can be provided in a respective component to be inhomogeneously arranged within a base component, can be used. For example, the active nutraceutical ingredient may be a dietary supplement, in particular a vitamin, a mineral, an herb or other botanical, an amino acid, a dietary substance for use by man to supplement the diet by increasing the total dietary intake, or a concentrate, metabolite, constituent, extract, or combination of any of the above ingredients. For example botanicals may be seeds, berries, leaves, roots, flowers or bark. For example, the active nutraceutical ingredient may further be an animal extract, like a fatty acid. This list is not limiting. Further, the nutraceutical delivery system according to the present invention may also comprise further components or substances, for example additives or the like.

According to a preferred embodiment, the nutraceutical active ingredient may be a dietary supplement. Further preferred, the nutraceutical active ingredient may be a vitamin, a mineral, an herb or other botanical, an amino acid, a dietary substance for use by man to supplement the diet by increasing the total dietary intake, or a concentrate, metabolite, constituent, extract, or combination of any of the above ingredients. According to another preferred embodiment, the nutraceutical delivery system may be free of any active pharmaceutical ingredients. according to a yet further preferred embodiment, the nutraceutical delivery system may be free of any pharmaceutical drug. In another preferred embodiment, the nutraceutical delivery system may be free of any therapeutical effects.

According to a further preferred embodiment of the present invention, the nutraceutical delivery system may be produced with a screen-printing technique, in particular a 3D-screen printing technique. By using a screen-printing technique, a precise control of the arrangement of the first component within the base component of the nutraceutical delivery system may be achieved. For example, a particular mesh can be used for arranging the components in the nutraceutical delivery system by means of the screen-printing technique. The respective components may be provided in forms of pastes. The pastes may be arranged relatively to one another with the screen-printing technique. In such a case, the active nutraceutical ingredient may be soluble in the respective paste.

According to a yet further embodiment of the present invention, the system is produced by alternatingly performing the following steps of screen-printing and curing a base paste comprising the base component, and screen-printing and curing a first paste comprising the first component. Also further pastes may be used to provide a second component with a second active nutraceutical ingredient, for example.

According to a yet further embodiment of the present invention, the nutraceutical delivery system may be formed of and/or manufactured by a plurality of layers, preferably more than 2, preferably more than 3, preferably more than 5, preferably more than 10, preferably more than 15, preferably more than 20, preferably more than 25, preferably more than 50, preferably more than 75, preferably more than 100. The nutraceutical delivery system may furthermore be formed of 500 layers at the most, preferably of 400 layers at the most, 350 layers at the most, 300 layers at the most, 250 layers at the most, 150 layers at the most, 100 layers at the most, 75 layers at the most, 50 layers at the most, 25 layers at the most or 15 layers at the most.

According to a yet further embodiment of the present invention, at least one layer layers or a plurality of layers or all layers of the nutraceutical delivery system may have a constant thickness and/or a constant concentration of any ingredient or component. At least two or more layers may have identical compositions and/or dimensions.

According to a further aspect, the present invention relates to the use of a nutraceutical delivery system as described above for the controlled administration of one or more active nutraceutical ingredients to a body, in particular the body of a human.

### BRIEF DESCRIPTION OF THE DRAWINGS

The present invention will, in the following, be described with reference to the enclosed figures.

FIGS. 1A to 11 show several designs of nutraceutical delivery systems according preferred embodiments of the present invention;

FIG. 2A shows a further design of a nutraceutical delivery system according to a further embodiment;

FIG. 2B shows a concentration profile corresponding to the embodiment in FIG. 2A;

FIG. 3A shows an active nutraceutical ingredient release profiles of a common nutraceutical delivery system;

FIGS. 3B to 3C show active nutraceutical ingredient release profiles of nutraceutical delivery systems according to embodiments of the present invention;

FIGS. 4A to 4D show further designs of nutraceutical delivery systems according to embodiments of the present invention;

FIGS. 5A to 5D show further designs of nutraceutical delivery systems according to embodiments of the present invention;

FIG. 6 shows a further design of a nutraceutical delivery system according to an embodiment of the present invention; and

FIG. 7 shows a structured nutraceutical delivery system according to an embodiment the present invention.

### DETAILED DESCRIPTION

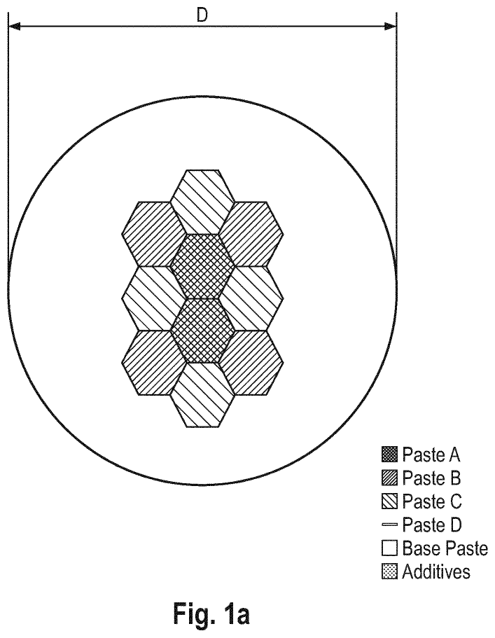

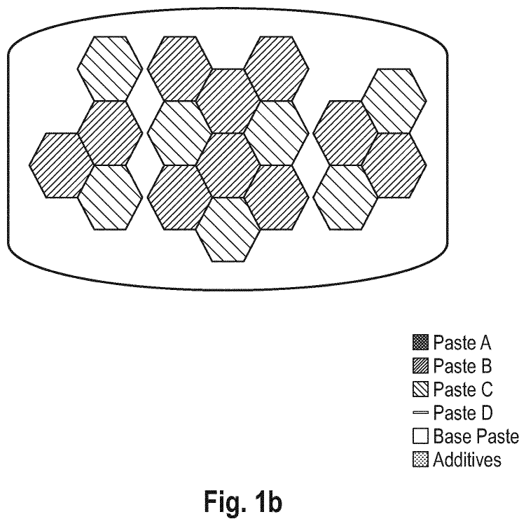

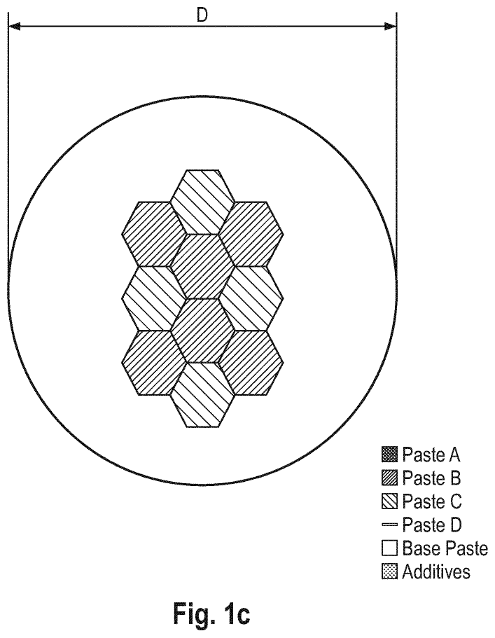

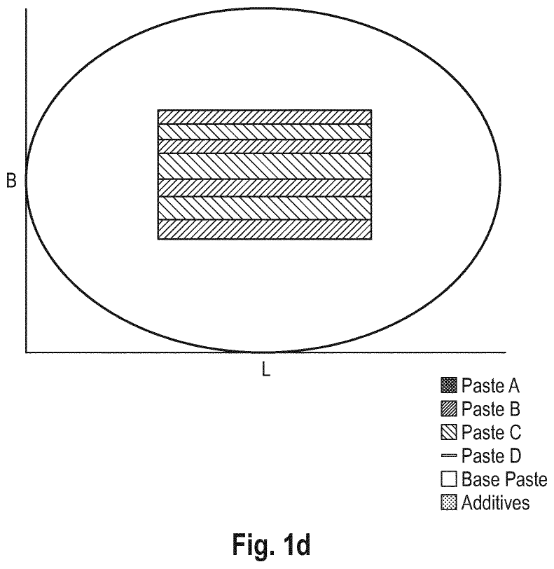

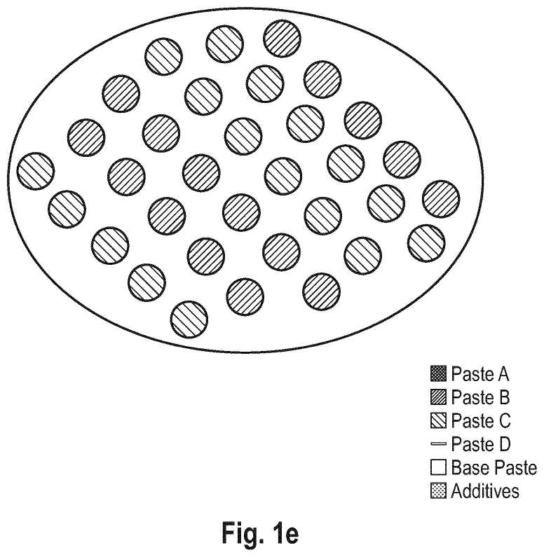

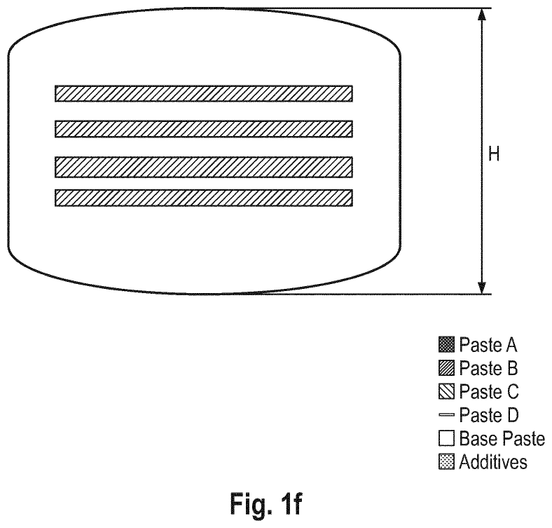

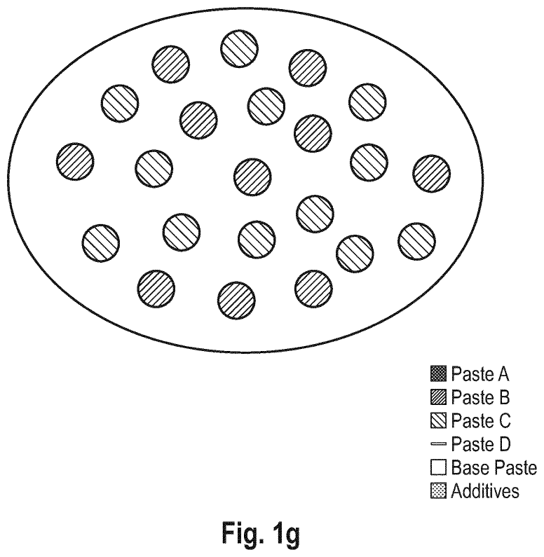

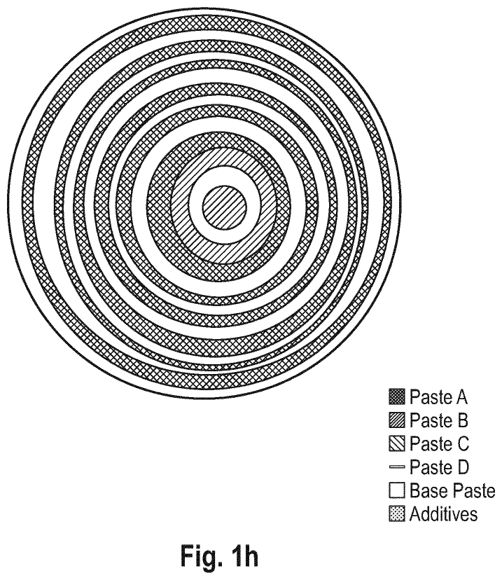

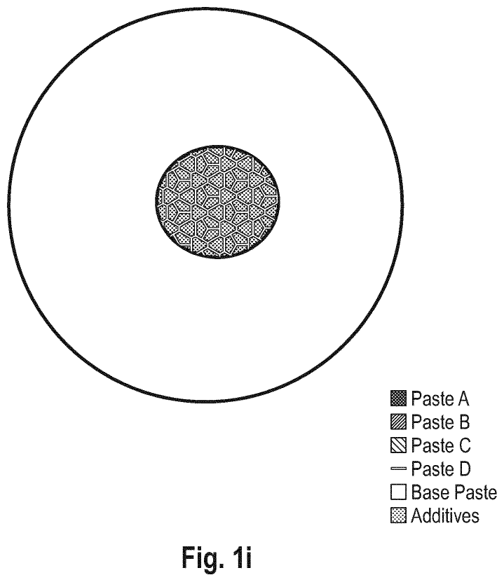

FIGS. 1A to 11 illustrate a total of nine design options for a nutraceutical delivery systems according to embodiments of the present invention. It may be seen that all the designs in FIGS. 1A to 11 comprise a base component, which may form the overall body of the respective nutraceutical delivery system. The base component may be considered as a matrix. Within said matrix further components may be arranged. These further components are marked as component A, component B, component C, and component D. Each component may comprise an effective amount of a separate active nutraceutical ingredient. Accordingly, any of the components A-D may be considered as a first component within the meaning of the present invention. The base component as well as any one of the components A-D may be soluble in body fluids, such as, for example, in gastric acid or the like.

The design of nutraceutical delivery system according to the embodiment shown in FIG. 1A may have a round shape. The Nutraceutical delivery system in FIG. 1A may have the form of a tablet, a disc or the like. Such Nutraceutical delivery system may have a particular diameter D. The diameter D may be, for example, 15 mm. Also Nutraceutical delivery systems with other diameters may be provided.

Within the base component of the nutraceutical delivery system according to the embodiment in FIG. 1A, a first component A with a first active nutraceutical ingredient, a second component B with a second active nutraceutical ingredient and a third component C with a third active nutraceutical ingredient may be provided. It may be comprehended from FIG. 1A that the respective active nutraceutical ingredients are not distributed homogeneously throughout the nutraceutical delivery system. Instead the active nutraceutical ingredients are arranged inhomogeneously within the base component. In particular, the components A, B, C may be provided at particular positions within the nutraceutical delivery system. The components A, B, C may, for example, be provided in a polygonal shape, and preferably with a hexagonal cross section.

Upon application of nutraceutical delivery system in accordance with the embodiment shown in FIG. 1A, the base component may dissolve first, as the dissolution of the entire system may begin at the edge of the system. After a certain and/or predetermined period of time, component C and then component B may start to dissolve. Thereby the respective active nutraceutical ingredients may be released, particularly in a controlled and/or adjusted manner. Subsequently, component A may start to dissolve. Thereby the respective first active nutraceutical ingredient provided therein may be released. Due to the particular arrangement of the components in the nutraceutical delivery system, the different active nutraceutical ingredients may be released at different stages and/or at different dosages after application of the nutraceutical delivery system. Due to the particular arrangement of the different components within and/or throughout the nutraceutical delivery system according to the embodiment in FIG. 1A, each active nutraceutical ingredient may be released at a particular time after application of the nutraceutical delivery system. Such release may have a particular and/or individual profile. In particular, an active nutraceutical ingredient-specific release profile may be obtained.

The nutraceutical delivery system in accordance with the embodiment in FIG. 1B may be formed as a tablet. Such a tablet may have a height of, for example, 2.5 mm. Furthermore, such a tablet may have a diameter of 15 mm. The components B and C, each having an active nutraceutical ingredient, may be provided within the base component in an inhomogeneous manner. Upon application of the system according to the embodiment of FIG. 1B, particular release profiles of the active nutraceutical ingredients within components B and C may be obtained. Smooth transitions between phases of increased release may thereby be obtained.

The nutraceutical delivery system in accordance with the embodiment in FIG. 1C may be similar to that of nutraceutical delivery system in accordance with FIG. 1A, however comprising, beside the base component, merely two components B and C. Components B and C may each comprise an active nutraceutical ingredient. With application of such system, particular release profiles of the active nutraceutical ingredients contained in components B and C may be obtained. Smooth transitions between phases of increased release may be achieved in this manner.

In the nutraceutical delivery system in accordance with the embodiment in FIG. 1D, two components with active nutraceutical ingredients may be provided in a tube-like shape. Alternatively, the components may be provided in form of stacked plates or the like.

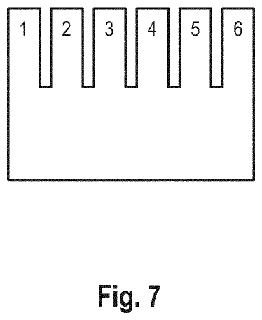

The nutraceutical delivery system in accordance with the embodiment in FIG. 7 has a design where the components with active nutraceutical ingredients may be provided as spots within or throughout the base component. By applying such system, particular and/or specifically adjusted release profiles of the active nutraceutical ingredients within components B and C may be obtained. Smooth transitions between phases of increased release may be achieved in this manner.

The nutraceutical delivery system in accordance with the embodiment in FIG. 1F has a design of a particular height H, for example, a height H of 25 mm. Only one component with an active nutraceutical ingredient may be arranged inhomogeneously within the respective base component. The component with the active nutraceutical ingredient may be provided in a tube-like manner, particular by the arrangement of a plurality of tube shaped elements. Alternatively, the component may be provided in form of plates or the like.

The nutraceutical delivery system in accordance with the embodiment in FIG. 1G may be similar to nutraceutical delivery system in accordance with the embodiment in FIG. 1E, However the components with active nutraceutical ingredients may be arranged in a more random manner. With application of the system, particular release profiles of the active nutraceutical ingredients within components B and C may be obtained. Smooth transitions between phases of increased release may be achieved.

The nutraceutical delivery system in accordance with the embodiment in FIG. 1H has a design, where the components with the active nutraceutical ingredients may be provided and/or arranged in the form of circles within and/or throughout the base component. By applying such nutraceutical delivery system, the base component and the first component may dissolve in an alternating manner. That is, the first active nutraceutical ingredient may be released intermittently, particularly in a periodic manner. Subsequent to the complete release of the first active nutraceutical ingredient, the second component may start dissolving. Thereby the second active nutraceutical ingredient may be released. It may be comprehended that the circles of component A are not necessarily concentric. The circles may also not have any uniform thickness. A particular and/or specifically adjusted release profile may be obtained due to this particularly inhomogeneous arrangement. Smooth transitions between phases of increased release may be achieved in this manner.

The nutraceutical delivery system in accordance with the embodiment in FIG. 11 has a design where a component with an active nutraceutical ingredient may be provided in a particular pattern within a matrix of additives. The matrix of additives may be arranged within the base component.

Each of the embodiments described above with regard to FIGS. 1A to 11 may provide a particular release characteristics with regard to the active nutraceutical ingredient or the plurality of ingredients provided therein, respectively. In accordance with the present invention, it is possible to choose design suitable for a given application, said design having an inhomogeneous arrangement of the active nutraceutical ingredient in the base component, therewith particularly achieving a desired release profile or characteristic.

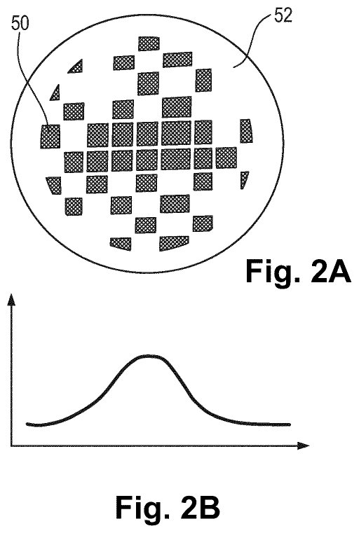

FIG. 2A shows a design of a nutraceutical delivery system according to a further embodiment of the present invention. According to this embodiment, the component 10 with the active nutraceutical ingredient and the base component 12 may be arranged on a grid-like structure. Each “pixel” of the grid-like structure may be defined by the active nutraceutical ingredient component or the base component. It may be comprehended that the two components 10 and 12 are arranged such that the density of pixels provided by the active nutraceutical ingredient component 10 may be higher at a central part or central portion of the nutraceutical delivery system. This may also become apparent from the concentration profile of the active nutraceutical ingredient component 10, as shown in FIG. 2B. Said concentration profile has a peak of high active nutraceutical ingredient concentration at a center of the system. Furthermore, a rather low concentration of the active nutraceutical ingredient is provided at the edges of the system. There may, in turn, be a rather smooth transition from the low concentration of the active nutraceutical ingredient at the edges to the high concentration of the active nutraceutical ingredient at the center. Thus, the transition may be free of any abrupt steps or the like. The release profile of such nutraceutical delivery system upon dissolution of the two components may be adjusted or configured in a desired and/or specifically chosen manner.

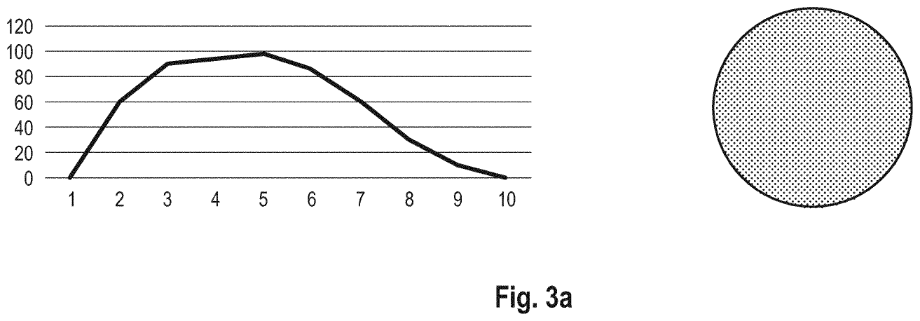

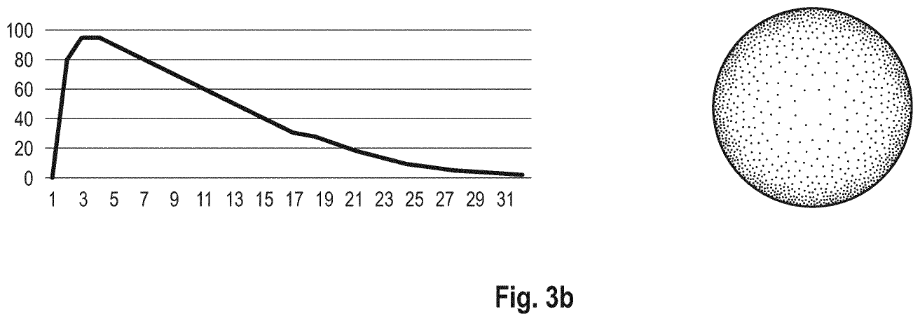

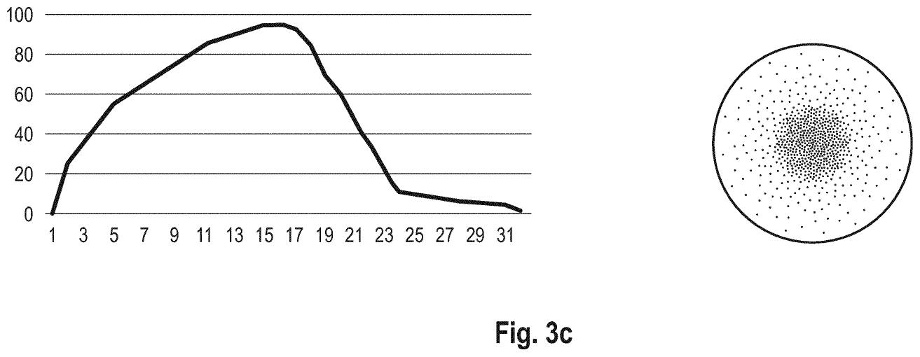

FIG. 3A shows the release profile of a common nutraceutical delivery system comprising a homogeneously distributed active nutraceutical ingredient. FIGS. 3B and 3C show release profiles of a nutraceutical delivery systems according to the present invention. In FIGS. 3A to 3C, the design of the respective nutraceutical delivery system is shown next to the graphs. The nutraceutical delivery systems may be provided in a round shape. More particular, the nutraceutical delivery systems may, for example, be provided in form a tablet dissolving upon oral administration. The respective graphs in FIGS. 3A to 3C each show the release of the respective active nutraceutical ingredient of the respective nutraceutical delivery system over a given period of time.

According to the graph in FIG. 3A, the respective nutraceutical delivery system is designed in a manner such that the active nutraceutical ingredient is homogeneously distributed throughout the system. This homogeneous distribution may be considered as key feature of common prior art nutraceutical delivery systems. The homogeneous distribution is due to the corresponding manufacturing processes. With application and dissolution of a classical nutraceutical delivery systems, the respective active nutraceutical ingredient may be released. In view of the dissolution characteristics of such homogeneous system and the shape of such a system, a particular and fixed release profile may be obtained. It may be comprehended from the graph in FIG. 3A that the release of the active nutraceutical ingredient increases gradually over time, subsequently reaches a maximum, and then decreases gradually again.

In view of the inhomogeneous arrangement of the active nutraceutical ingredient in accordance with the present invention, different release profiles may be achieved. The design corresponding with the graph in FIG. 3B is different from that corresponding to the graph in FIG. 3A, specifically concerning the active nutraceutical ingredient being arranged at an edge of the nutraceutical delivery system. Therefore, the homogeneous distribution of the active nutraceutical ingredient, as provided in common systems, may be suspended. The active nutraceutical ingredient may accordingly be inhomogeneously arranged in the system. In this case a high concentration at the edge of the system may be provided. Furthermore, the concentration of the active nutraceutical ingredient may smoothly decrease towards the center of the system. By applying such nutraceutical delivery system corresponding to the graph in FIG. 3B, the release of the active nutraceutical ingredient may be rather high in the beginning and may subsequently decrease in a gradual manner. A high initial release of an active nutraceutical ingredient may be beneficial for certain applications.

According to the design corresponding with the graph in FIG. 3C, the active nutraceutical ingredient may be accumulated at a central part of the nutraceutical delivery system. In this case, the concentration of the active nutraceutical ingredient may be relatively high or highest at the center of the system. Thus, a gradient of concentration may point from the edge of the system to its center. It may be comprehended from the respective graph in FIG. 3C that the release increases approximately gradually over a prolonged period of time. Accordingly, the maximum release rate may be delayed in time in comparison to a common design with a homogenous distribution of the respective nutraceutical ingredient. The release of the active nutraceutical ingredient can be considered to be more constant for an extended period of time, as compared to a common design. A release profile in accordance with the graph in FIG. 3C may be beneficial for certain applications.

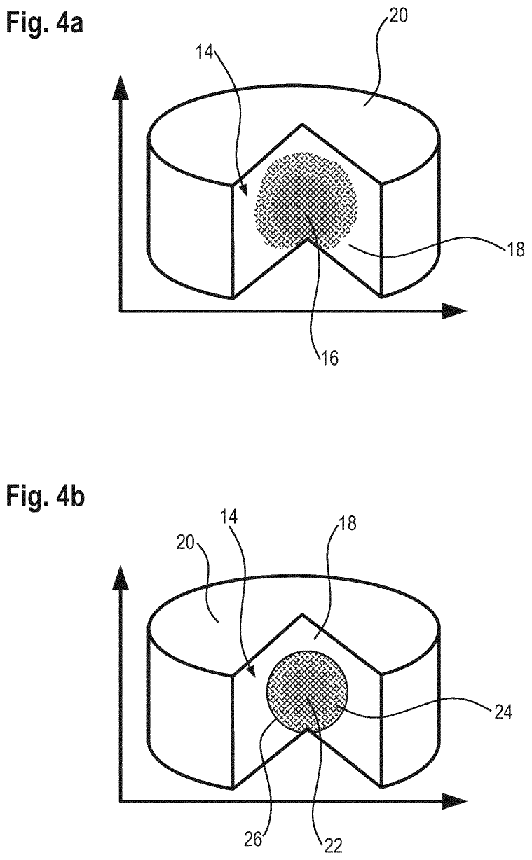

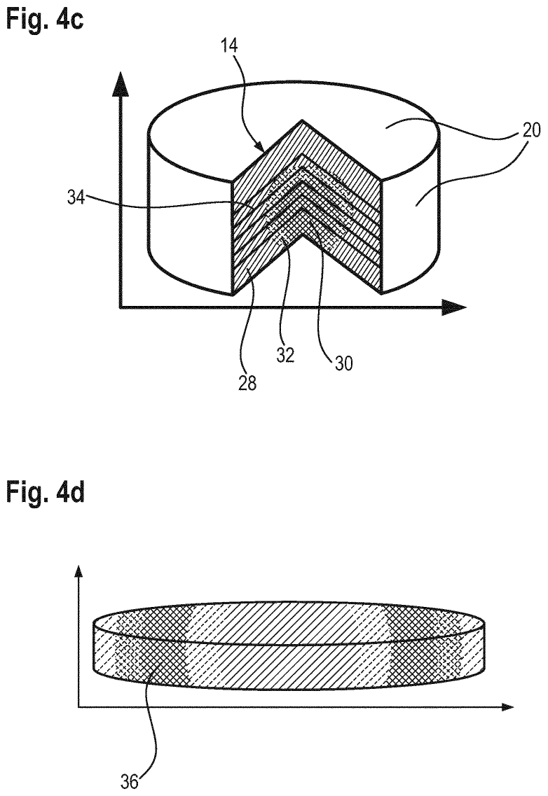

FIGS. 4A to 4D show further embodiments of a nutraceutical delivery system according to the present invention. The overall shape of the systems may be that of a round disk, for example, with a diameter of 5-25 mm, preferably 20 mm or 15 mm, and, for example, with a thickness of 0.5-15 mm, preferably 2 mm or 6 mm. The tablets in FIGS. 4A to 4C are depicted with a cut 14 to allow for a view into the tablets and therewith on the arrangement of the components in the tablets.

The design of nutraceutical delivery system according to the embodiment in FIG. 4A has a first component 16 with a first active nutraceutical ingredient. The first active nutraceutical ingredient may be provided at the central part of the tablet, and furthermore surrounded by a base component 18. The entire tablet may be coated with a coating 20. Said coating 20 may, for example, be a hydrophilic coating. The coating 20 may also provide enteric coated properties, for example. The concentration of the active nutraceutical ingredient within the tablet may be relatively high or highest at the center of the tablet. The concentration profile of the active nutraceutical ingredient may be adjusted in a manner such that a smooth transition from the edge of the tablet towards the center of the tablet is achieved. The transition is indicated by different cross hatches in FIG. 4A.

The design of nutraceutical delivery system according to the embodiment in FIG. 4B has a first component 22 with a first active nutraceutical ingredient and a second component 24 with a second active nutraceutical ingredient. The components may be provided within a base component 18, as may be comprehended from FIG. 4B. A coating 20 may again be provided. The second component 24 may be arranged in the form or a sphere. A concentration of the second active nutraceutical ingredient may be relatively high or highest on the surface 26 of such sphere. The concentration may furthermore smoothly decrease towards the center of the sphere. The first component 22 may be provided within and/or throughout the sphere formed of the second component 24. By applying the tablet and with dissolution of the components 22 and 24 of the tablet, the second active nutraceutical ingredient may be released prior to the first active nutraceutical ingredient. Both active nutraceutical ingredients may be released within a transition period.

In the design of nutraceutical delivery system according to the embodiment in FIG. 4C two different active nutraceutical ingredients 28 and 30 may be provided.

The second active nutraceutical ingredient 30 may be provided at a central part of the tablet. The first active nutraceutical ingredient 28 may be provided around the second active nutraceutical ingredient 30. There may furthermore be provided an interface region 32 between both active nutraceutical ingredients. In tis interface region, an overlap of the active nutraceutical ingredients 28 and 30 may be present. Thus, in this interface region 32, both active nutraceutical ingredients 28 and 30may be arranged. A smooth crossover may thereby be achieved. Finally, also layers 34 may be provided in this embodiment, said layers 34 extending through the system. The layers 34 may be hydrophobic layers. The layers 34 may particular have dissolution resistant and/or dissolution delaying properties, as mentioned above.

The design of nutraceutical delivery system according to the embodiment in FIG. 4D may be free of any coating. An active nutraceutical ingredient 36 may again be inhomogeneously arranged in the tablet. Thus, areas or regions with different concentrations of the active nutraceutical ingredient may be provided in this embodiment, as indicated with different hatch types in FIG. 4D.

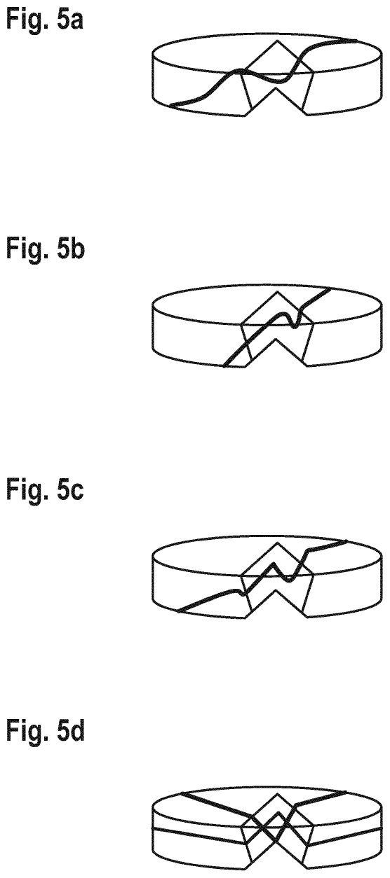

FIGS. 5A to 5D show further embodiments of a nutraceutical delivery system according to the present invention. The overall shape of the systems shown in FIGS. 5A to 5D may be that of a round disk with a particular thickness. As may be comprehended, the systems may comprise one or more markings. The markings may, in turn, be arranged at least partially on the surface of the tablets. Accordingly, the markings may form a visible and/or two-dimensional pattern on the surface of the tablets. As may be comprehended from FIG. 5, the pattern of the marking may be a discontinuous pattern. Said pattern may also comprise smooth curves and/or sharp edges. The pattern may therefore be arranged in an inhomogeneous manner. The markings may, for example, be formed by a particular marking component. The markings may also be provided by a component with an active nutraceutical ingredient. Nutraceutical delivery systems with such markings may be considered to comprise a particular security feature. That is, with such markings, security features may be created. Such security features may allow authenticating the origin of the nutraceutical delivery system by a user or consumer of the system.

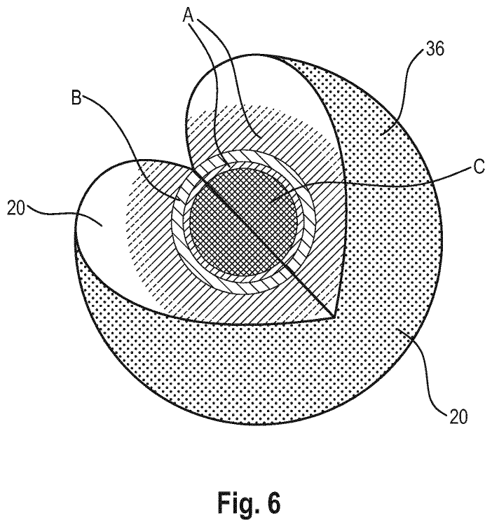

FIG. 6 shows a further embodiment of a nutraceutical delivery system according to the present invention. The system according to FIG. 6 may be provided in a spherical shape. The system may furthermore be provided with a coating 20, particularly a hydrophobic coating. Such a coating may comprise hydrophilic pores 36. The pores 36 may have sizes in the range of 1 μm to 500 μm, for example. There may be provided a base component 20 and also three different active nutraceutical ingredients inside the nutraceutical delivery system. The three different active nutraceutical ingredients may be active nutraceutical ingredient A, active nutraceutical ingredient B, and active nutraceutical ingredient C. Active nutraceutical ingredient C may, for example, be provided at a central part of the system with a peripheral pattern. The further two active nutraceutical ingredients A and B may, for example, surround active nutraceutical ingredient C. Active nutraceutical ingredient B may be provided as a hollow sphere and/or with a homogeneous distribution of the respective active nutraceutical ingredient. Further to this, there may be provided an inhomogeneous distribution of active nutraceutical ingredient A, surrounding the active nutraceutical ingredient C. The concentration of active nutraceutical ingredient A may thereby diminish towards an edge of the nutraceutical delivery system shown in FIG. 6. The diminishing concentration of active nutraceutical ingredient A is indicated by different hatch types. The concentration may diminish smoothly towards the edge of the nutraceutical delivery system.

FIG. 7 shows a cross-section of a nutraceutical delivery system according to an embodiment of the present invention. As may be comprehended, the surface of the nutraceutical delivery system is structured. The structuring may be formed by protrusions and/or recesses. The protrusions and/or recesses may be formed on one side thereof of the system. Thereby the surface may be enlarged or increased, and due to this enlarged and/or increase surface, the dissolution of the nutraceutical delivery system can be enhanced. As a consequence, the release of the active nutraceutical ingredient may be enhanced and/or facilitated. It is possible that the entire surface of the nutraceutical delivery system may be structured in such a manner. It is likewise possible that only one or several parts or portions thereof may be structured in such a manner.

The nutraceutical delivery system according to the present invention allows to provide a particular inhomogeneous distribution of one or more active nutraceutical ingredients within the system. As a consequence, a desired release of the active nutraceutical ingredient(s) may be achieved. Possibly a prompt release or also a delayed release of an active nutraceutical ingredient may thereby be obtained. It is furthermore possible to release a particular single active nutraceutical ingredient at different dosages over a prolonged period of time. As an example, an intermittent release of an active nutraceutical ingredient may be provided. The release of the respective active nutraceutical ingredient(s) may accordingly occur phases.

It is likewise possible to obtain a release of different active nutraceutical ingredients in distinct phases with a single nutraceutical delivery system according to the present invention. The system may, for example, be designed in a manner such that a first active nutraceutical ingredient is released before a second active nutraceutical ingredient.

Possible design options based on the general concept of inhomogeneously arranging of one or more active nutraceutical ingredients in a nutraceutical delivery system are manifold. Accordingly, the examples and embodiments described above or shown in the figures can be combined to obtain further elaborate designs and/or embodiments with release profiles optimized to a particular application.

1. A nutraceutical delivery system, the system comprising:
a base component soluble in body fluids and provided as a three-dimensional body, and
a separate first component not mixed with the base component and soluble in body fluids,
wherein the first component comprises a first active nutraceutical ingredient,
wherein the first component is inhomogeneously arranged within a matrix formed of the base component, for providing a concentration profile, and
wherein the concentration profile of the first active nutraceutical ingredient is such that upon application of the system, the first active nutraceutical ingredient is released at two or more dosages, wherein release of the first active nutraceutical ingredient at one of the two or more dosages starts 1 second to 24 hours before release of the first active nutraceutical ingredient at another one of the two or more dosages.

2. (canceled)

3. (canceled)

4. The system of claim 31, wherein a concentration of the first active nutraceutical ingredient is highest at a center, at an edge, or at an intermediate region of the system.

5. The system of claim 1, wherein the concentration profile is a gradient of the concentration of the first active nutraceutical ingredient that increases towards or increases away from a center of the nutraceutical delivery system.

6. The system of claim 1, wherein the concentration profile of the first active nutraceutical ingredient throughout and/or within a portion of the system comprises a smooth transition to an area of increased and/or relatively high concentration.

7. The system of claim 1, wherein the concentration profile of the first active nutraceutical ingredient throughout the system comprises more than one area of increased and/or relatively high concentration.

8. The system of claim 1, wherein the concentration profile comprises a variation of the concentration of the first active nutraceutical ingredient throughout the system of at least 5%.

9. The system of claim 8, wherein the variation of the concentration of the first active nutraceutical ingredient throughout the system is 5% to 100%.

10. The system of claim 1, wherein the concentration profile of the first active nutraceutical ingredient is such that upon application of the system, the first active nutraceutical ingredient is released from the system at a predetermined release profile comprising a section with a release at a constant rate.

11. The system claim 1, wherein release of the first active nutraceutical ingredient at one of the two or more dosages starts 5 seconds to 12 hours before release of the first active nutraceutical ingredient at another one of the two or more dosages.

12. The system of claim 1, wherein the base component envelops the system and/or that the first component is not arranged at an outer face of the system and/or the outer face of the system is free of the first component.

13. The system of claim 1, comprising a separate second component soluble in body fluids, said second component comprising a second active nutraceutical ingredient.

14. The system of claim 13, wherein the second component is inhomogeneously arranged in the base component.

15. The system of claim 13, wherein the concentration profile of the first active nutraceutical ingredient throughout and/or within a portion of the system is different than a concentration profile of the active nutraceutical ingredient throughout and/or within a portion of the system.

16. The system of claim 13, wherein the first component and the second component are arranged in the system such that upon application of the system, release of the first active nutraceutical ingredient starts before release of the second active nutraceutical ingredient, optionally wherein the release of the first active nutraceutical ingredient starts 1 second to 24 hours before release of the second active nutraceutical ingredient.

17. The system of claim 13, wherein the first component and the second component are arranged in the system such that upon application of the system, a release profile, in particular a time release characteristic, of the first active nutraceutical ingredient differs from a release profile, in particular a time release characteristic, of the second active nutraceutical ingredient.

18. The system of claim 1, wherein the total amount of the first active nutraceutical ingredient in the system is between 1 pg and 100 g.

19. The system of claim 1, further comprising one or more of the components selected from a ceramic, metal, polymer, minerals, filler, solution binder, dry binder, and/or glidant.

20. The system of claim 1, further comprising a disintegration agent.

21. The system of claim 20, wherein the disintegration agent comprises
cellulose,
croscarmelose sodium,
crospovidone,
starches,
cross-linked polyvinylpyrrolidone,
sodium starch glycolate, and/or
sodium carboxymethylcellulose.

22. The system of claim 1, wherein the first component is provided in a geometrical shape and/or the first component is provided in a shape being a tube, a spot, an oval, a plate or a polygon.

23. The system of claim 1, further comprising a marking component optically different from the base component, the marking component being arranged such that it forms a two-dimensional pattern on the surface of the system and/or being visible from the outside.

24. The system of claim 1, wherein the first component is optically different from the base component and/or the first component is arranged such that it forms a two-dimensional pattern on the surface of the system and/or being visible from the outside.

25. The system of claim 23, wherein the two-dimensional pattern is a discontinuous pattern.

26. The system claim 1, wherein the system is in the form of
a tablet,
a capsule,
a disk,
a film,
pellets, or
granules.

27. The system according to claim 1, wherein the first active nutraceutical ingredient is selected from the group consisting of vitamins, minerals, herbs, amino acids, or dietary substances.

28. The system claim 1, wherein the system is produced with a screen-printing technique, optionally wherein the screen-printing comprises alternatively screen-printing and curing a base paste comprising the base component, and screen-printing and curing a first paste comprising the first component.

29. (canceled)

30. The system of claim 1, wherein first component is inhomogenously arranged such that the concentration profile is configured for controlled administration of the first nutraceutical ingredient.

31. A method of using the nutraceutical delivery system of claim 1, comprising applying the nutraceutical delivery system to a body for a controlled administration of one or more active nutraceutical ingredients to a body.

32. A nutraceutical delivery system, in the form of a tablet or capsule, comprising:
a base component soluble in body fluids, and provided as a three-dimensional body; and
a first nutraceutical component soluble in body fluids, the first nutraceutical component comprising an active nutraceutical ingredient;
wherein:
the base component and the first nutraceutical component are separate components arranged such that the first nutraceutical component defines within a matrix of the base component at least two, two and/or three-dimensional structures each having a resolution of 10 dpi to 10000 dpi,
wherein the first nutraceutical component is inhomogenously or discontinuously arranged along one, two or three spatial or orthogonal directions in the base component,
wherein the two and/or three-dimensional structures are arranged in separate locations of the matrix and with a concentration profile within the matrix, such that two or more dosages of the first nutraceutical component, that are not mixed with the base component, are releasable out of the system with release of one dosage starting within 1 second to 24 hours before release of another dosage, and
a concentration of the first nutraceutical component varies through the matrix of the base component.

33. The system of claim 31, wherein the system is free of release agents.
